(19) United States
(12) Patent Application Publication
(10) Pub. No.: US 2013/0050153 A1
(43) Pub. Date: Feb. 28, 2013

(54) Electric Device with Data Detection Function and Data Detection Method Thereof

(71) Applicant: Te-Wei Yang, Yangmei City (TW)

(72) Inventor: Te-Wei Yang, Yangmei City (TW)

(73) Assignee: ALTEK CORPORATION, Hsinchu (TW)

(21) Appl. No.: 13/243,237

(22) Filed: Sep. 23, 2011

(30) Foreign Application Priority Data
Aug. 30, 2011 (TW) 100131087

(51) Int. Cl. G06F 3/033

(52) U.S. Cl. 345/179

(57) ABSTRACT

An electric device with data detection function and a data detection method thereof. The device comprises an analysis module, an input module, a recognition module, a comparison module and a display module. The analysis module receives sensor information and analyzes the sensor information to get analysis information. The input module allows users to input feedback information. The recognition module is electrically connected to the input module; the recognition module recognizes and converts the feedback information into digital information. The comparison module is electrically connected to the input module and the recognition module. The comparison module compares the analysis information and the feedback information or the digital information to get a comparison result. The display module displays the analysis information or the comparison result.

### CROSS-REFERENCE TO RELATED APPLICATION

This application claims the benefit of Taiwan Patent Application No. 100131087, filed on Aug. 30, 2011, in the Taiwan Intellectual Property Office, the disclosure of which is incorporated herein in its entirety by reference.

### BACKGROUND OF THE INVENTION

1. Field of the Invention

The present invention relates to an electric device with data detection function and a data detection method thereof, in particular to the electric device that allows users to feed back a test result of a sensor.

2. Description of the Related Art

Common medical measurement devices including, for example, hemadynamometers, clinical thermometers or blood glucose meters, relate to the safety of human life, so the accuracy of measurement results is very important. Medical measurements must be computed and displayed accurately a user's current health conditions, so that the user can determine the current health conditions. For example, the normal body temperature is approximately 37, if the oral cavity temperature of a person is higher than 37.5, such person may be considered to be having a fever. If the fever continues at a temperature over 40, damage to brain function or even death may occur. Therefore, it is necessary to seek medical assistances immediately for the high fever condition. In other words, accurate measurements and displays of the electronic clinical thermometer are very important.

There is another medical measurement device for measuring a blood glucose concentration, for instance, a blood glucose meter. In general, if acquired diabetes of a patient was not very serious, the patient's blood glucose concentration would be controlled by diet control. The diabetes patients generally measure the blood glucose concentration three times after each meal a day, and the measured blood glucose value is provided for determining the patient's diet in order to control the blood glucose and maintain the patient's health.

In addition, as medical devices advance with the development with technologies, the detection technology is developed rapidly. Smartphone which is a mainstream product in the market may replace a general computer and a measurement device for storing medical information to facilitate users to take measurements and carry the device anytime and anywhere. In other words, diabetes patients can use the Smartphone to measure blood glucose values anytime to learn their current health condition quickly.

It is noteworthy to point out that a general closed medical measurement device can prevent possible errors of its use through strict research, development and design. However, the Smartphone is a mobile phone with an open system, and users can install or remove application software freely, so that if a user installed various different application programs, a normal application of all the functions could be difficult to regulate or verify. If the application software for blood glucose measurement and/or other games are installed and loaded into the Smartphone, it would be difficult to foresee whether or not to cause a medical measurement error when other application software were installed by the user.

Therefore, in case of needs, a design of an electric device with data detection function and a data detection method thereof are required to let users feed back whether or not the results measured by the electric device are correct, so as to provide instant computations, comparisons with the accuracy of data and prevention of patients' life from being jeopardized, and the aforementioned requirement has become an issue that demands immediate attentions and feasible solutions to the market application.

### SUMMARY OF THE INVENTION

In view of the problems of the prior art, it is a primary objective of the present invention to provide an electric device with data detection function and a data detection method thereof to overcome the problems of incapable of determining whether measurement results obtained from an electric measurement device are correct.

To achieve the aforementioned objective, the present invention provides an electric device with data detection function, comprising an analysis module, an input module, a recognition module, a comparison module and a display module. The analysis module is provided for receiving and analyzing sensor information to generate analysis information. The input module is provided for inputting feedback information. The recognition module is electrically coupled to the input module for recognizing the feedback information and converting the feedback information into digital information. The comparison module is electrically coupled to the input module and the recognition module for comparing the analysis information with the feedback information or digital information to generate a comparison result. The display module is provided for displaying the analysis information or comparison result.

Preferably, the input module is a handwriting device, and the feedback information further includes handwriting information. The recognition module is provided for recognizing the handwriting information and converting the handwriting information into digital information.

Preferably, the electric device with data detection function further comprises a storage module for storing a tracking of the analysis information, digital information or handwriting information.

Preferably, the analysis module further comprises a conversion unit for converting the analysis information into image information, and the comparison module compares the image information with the handwriting information to obtain a comparison result.

Preferably, the display module is provide for displaying the analysis information, and the comparison module is provided for comparing the analysis information with the feedback information to obtain a comparison result.

Preferably, the analysis module further comprises a computation unit for analyzing the sensor information to obtain analysis information, and the comparison module compares the analysis information with the digital information to obtain a comparison result.

Preferably, the electric device with data detection function is a medical detection device, and the electric device further comprises a biosensor module for providing sensor information.

To achieve the foregoing objective, the present invention further provides an electric device with data detection function, comprising an analysis means, an input means, a recognition means, a comparison means and a display means. The analysis means is provided for receiving and analyzing the sensor information to generate analysis information. The input means is provided for inputting feedback information. The recognition means is provided for recognizing the feedback information and converting the feedback information into digital information. The comparison means compares the analysis information with the feedback information or the digital information to generate a comparison result. The display means is provided for displaying the analysis information or comparison result.

To achieve the foregoing objective, the present invention further provides a data detection method applicable for an electric device, and the electric device comprises an analysis module, an input module, a recognition module, a comparison module and a display module, and the data detection method comprises the following steps of: using the analysis module to analyze sensor information so as to generate analysis information; using the input module to input feedback information; using the recognition module to recognize the feedback information and to convert the feedback information into digital information; using the comparison module to compare the analysis information, the feedback information or the digital information to obtain a comparison result; and using the display module to display the analysis information or the comparison result.

Preferably, the feedback information includes handwriting information, and this method further comprises providing a recognition module to recognize the handwriting information; and the recognition module converts the handwriting information into digital information.

Preferably, this method further comprises using a storage module to store a tracking of the analysis information, digital information or handwriting information.

Preferably, the analysis module comprises a conversion unit, and this method further comprises using the conversion unit to convert the analysis information into image information; and using the comparison module to compare the image information with the handwriting information to obtain a comparison result.

Preferably, this method further comprises using the display module to display the analysis information; and the comparison module to compare the analysis information with the feedback information to obtain a comparison result.

Preferably, the analysis module comprises a computation unit, and this method further comprises using the computation unit to analyze the sensor information and to obtain analysis information; and a comparison module to compare the analysis information with the digital information to obtain a comparison result.

In summation of the description above, the electric device with data detection function and the data detection method thereof in accordance with the present invention can overcome the problems of the prior art that is incapable of confirming the accuracy of data viewed by the users. With the input module for inputting the feedback information, and the comparison module for comparing the analysis information, feedback information or digital information to obtain the comparison result, the electric device can achieve the effects of verifying the accuracy of the measurement result to effectively reduce the possibility of having errors of the electric device, preventing the occurrence of unpredicted danger, and improving the accuracy of the measuring physiological information in users.

The foregoing or other objectives, characteristics and advantages of the present invention will become apparent with the detailed description of preferred embodiments together with the illustration of related drawings as follows.

### BRIEF DESCRIPTION OF THE DRAWINGS

FIG. 1 is a block diagram of an electric device with data detection function in accordance with the present invention;

FIG. 2 is a schematic view of an electric device with data detection function in accordance with a first embodiment of the present invention;

FIG. 3 is a schematic view of an electric device with data detection function in accordance with a second embodiment of the present invention;

FIG. 4 is a schematic view of an electric device with data detection function in accordance with a third embodiment of the present invention; and

FIG. 5 is a flow chart of a data detection method of the present invention.

### DESCRIPTION OF THE PREFERRED EMBODIMENTS

The following will referred to the related drawings to describe an electric device with data detection function and a data detection method thereof according to the embodiments of the present invention. For better understanding, the same element is depicted by the same reference numeral in the following embodiment.

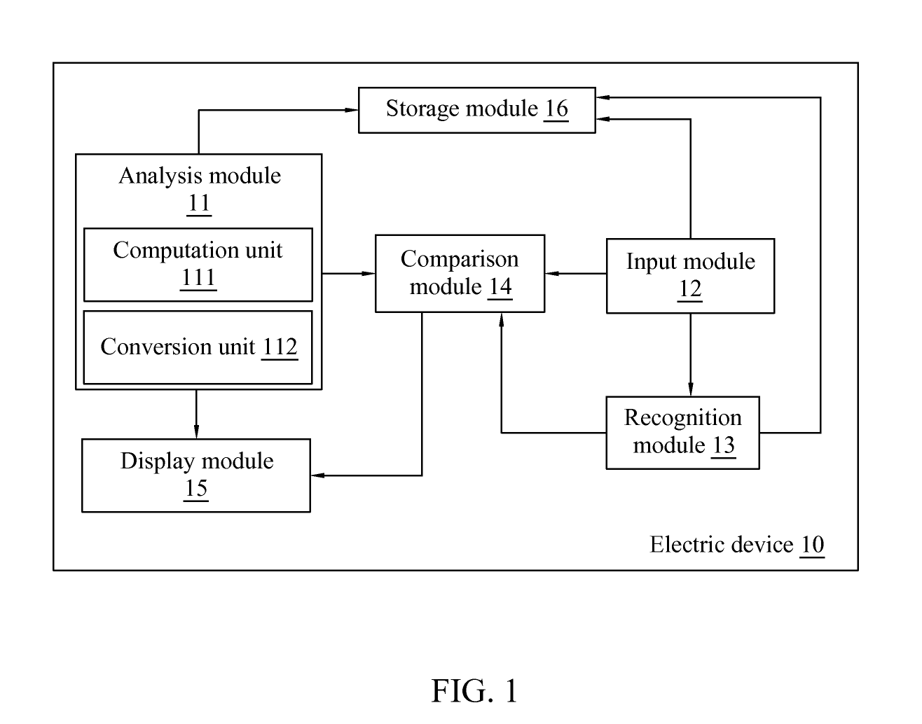

With reference to FIG. 1, for a block diagram of an electric device with data detection function in accordance with the present invention, the electric device with data detection function may be a medical measurement device such as a glucose meter, an electronic clinical thermometer, a hemadynamometer or an oximeter for measuring different physiological conditions. To illustrate the technical characteristics of the present invention, the glucose meter is adopted as an embodiment, but the invention is not limited to the glucose meter only.

First of all, referring to FIG. 1, the electric device 10 comprises an analysis module 11, an input module 12, a recognition module 13, a comparison module 14, a display module 15 and a storage module 16. In addition, a sensor may be built-in or externally connected to the electric device 10 (not shown in the figure). The analysis module 11 receives sensor information from a sensor and analyzes the sensor information to generate analysis information. Wherein, the analysis module 11 comprises a computation unit 111 and a conversion unit 112. The computation unit 111 may analyze the sensor information to obtain the analysis information, and the conversion unit 112 may convert the analysis information into image information. The input module 12 is provided for users to input feedback information, and the feedback information further includes handwriting information, and the input module 12 may be a keypad, a touchpad or various of their combination used as an input device. The recognition module 13 is electrically connected to the input module 12 for recognizing the feedback information and converting the feedback information into digital information, and recognizing the handwriting information and converting the handwriting information into digital information. In addition, the comparison module 14 is electrically connected to the input module 12 and the recognition module 13 for comparing the analysis information with the feedback information or digital information to obtain a comparison result. The display module 15 displays the analysis information or the comparison result. The storage module 16 stores a tracking of the analysis information, digital information or handwriting information.

According to the above-mentioned, after the analysis module 11 converts the analysis information into image information, the comparison module 14 compares the image information with the handwriting information to obtain a comparison result. The image information includes many types of schematic information, such as tables, figures or animations, but not limited to the aforementioned image information only. In addition, after the display module 15 displays the analysis information, the comparison module 14 compares the analysis information with the feedback information to obtain a comparison result. After the analysis module 11 analyzes the sensor information to obtain analysis information, the comparison module 14 compares the analysis information with the digital information to obtain a comparison result.

When the electric device 10 displays the measurement result through the display module 15, the input module 12 is provided for inputting the feedback information to verify the accuracy of the analyzed data. Therefore, the problems of having a wrong display from the display module 15, a hardware failure or a wrong memory access, and a misjudgment of the physiological conditions of the users can be avoided.

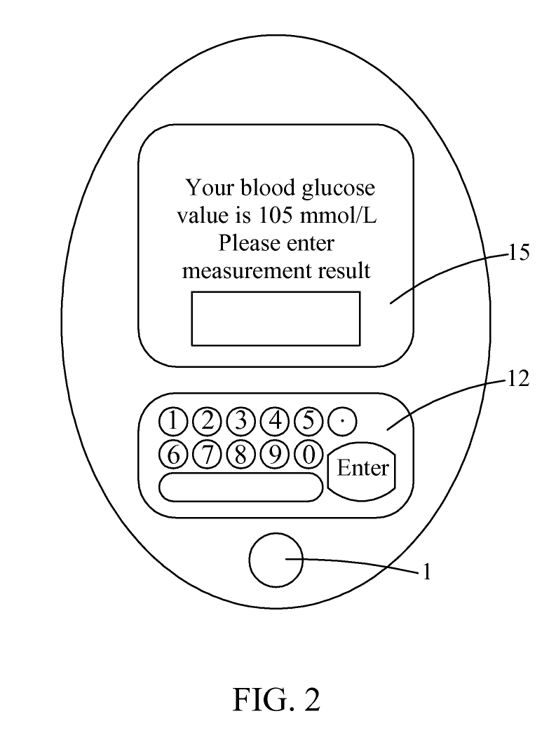

With reference to FIG. 2, for a schematic view of an electric device with data detection function in accordance with the first embodiment of the present invention, the electric device 10 in the present invention may be a glucose meter. With reference to FIG. 1 as well, a sensor may be built-in or externally connected to the electric device 10 of this preferred embodiment. To make it easier to understand the technical characteristics of the present invention, an electric device 10 with a built-in sensor 1 is used as an embodiment, but the invention is not limited to such arrangement only. Therefore, users can drop blood on the sensor 1 to input and provide sensor information to the analysis module 11 to receive and analyze the sensor information to generate analysis information, which is a blood glucose value equal to 10.5 (mmol/L). In the meantime, a storage module 16 is provided for storing analysis information which is a blood glucose value equal to 10.5 (mmol/L), and the storage module 16 may include an embedded memory, an external memory card or their combination. The display module 15 used for displaying the blood glucose value equal to 105 (mmol/L), and the display module 15 may include various display devices with display functions such as a flat panel display, a Liquid Crystal Display (LCD) or a Light-Emitting Diode display (LED display). To provide the users to input the blood glucose value equal to 105 (mmol/L) seen on the display module 15 by the users in the input module 12, the input module 12 may be various input devices, such as a keypad, a touchpad or their combination. To make it easy to understand the technical characteristics of the present invention, an embodiment of the keypad 3 is used for illustrating the present invention, but the invention is not limited to such arrangement only. The recognition module 13 is provided for recognizing the feedback information and converting the feedback information into digital information.

According to the above-mentioned, the comparison module 14 is electrically connected to input module 12 and recognition module 13 for comparing the digital information with the analysis information equal to 10.5 (mmol/L), such that the comparison allows users to obtain a comparison result to verify the false analysis of the computation unit 111. Meanwhile, the comparison module 14 can compare the blood glucose value equal to 105 (mmol/L) displayed on the display module 15 with the feedback information equal to 105 (mmol/L) inputted from the input module 12 to obtain a comparison result, and display the comparison result from the display module 15. Therefore, it is observed that the analysis information is different from the information displayed on the display module 15, 10.5 (mmol/L) in the analysis information but 105 (mmol/L) in the information displayed on the display module 15. Therefore, we know that there is an error in the comparison result of the glucose meter, and the feedback information is different from the result measured by the electric device 10. Thus, the accuracy of the data measured and displayed by the glucose meter may be verified by the data detection method of the present invention.

In this way, the electric device 10 using the present invention may be inputted through the input module 12 with the display information seen by the users, so that the electric device with data detection function 10 can verify the accuracy of measured data according to the feedback information inputted by the users. The glucose meter of this preferred embodiment is used as an example for illustrating the prevent invention only, but not intended for limiting the scope of the invention, and thus those ordinarily skilled in the art should understand that other equivalent devices are applicable with the electric device with data detection function 10 of the present invention.

Based on the first preferred embodiment, the present invention further provides a second preferred embodiment for the further illustration as follows.

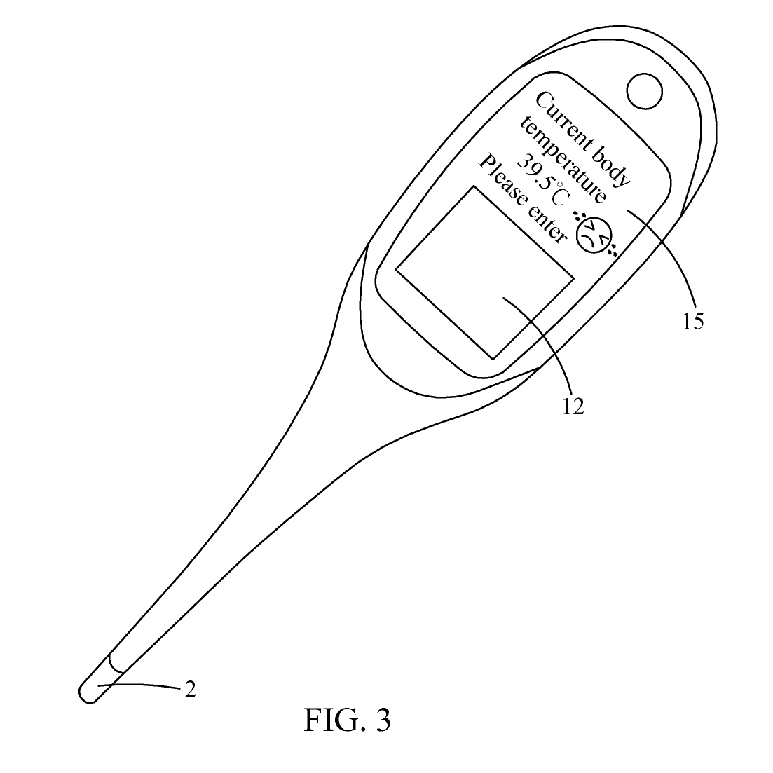

With reference to FIG. 3, for a schematic view of an electric device with data detection function in accordance with the second embodiment of the present invention. The electric device with data detection function 10 may be a medical measurement device, such as a glucose meter, an electronic clinical thermometer, a hemadynamometer, an oximeter, a Personal Digital Assistant (PDA) or a Smartphone, for inspecting various physiological conditions. To make it easy to understand the technical characteristics of the present invention, the following electronic clinical thermometer is used as an embodiment, but the invention is not limited to the application of the electronic clinical thermometer only. In FIG. 3, the electric device with data detection function 10 of the present invention may be an electronic clinical thermometer.

In this preferred embodiment as shown in FIGS. 1 and 3, a sensor may be built-in or external connected to the electric device 10. For better understanding the technical characteristics of the present invention, the following is the electric device 10 installed with a built-in sensor 2 as an embodiment, but the invention is not limited to such arrangement only. A user can use the built-in sensor 2 of the electric device 10 to detect and to measure a human body temperature and a computation unit 111 to analyze the detected temperature to obtain analysis information, which is equal to 39.5. And then a storage module 16 is used to store the analysis information which is the body temperature equal to 39.5. In the meantime, the conversion unit 112 is provided to convert the analysis information 39.5 into image information such as a form or a figure according to body temperature changes measured each time. Wherein, the image information may be information including a form, a figure or an animation. To make it easy to understand the technical characteristics of the present invention, a figure is used in following preferred embodiment for illustrating the invention, but the invention is not limited to such arrangement. In addition, the display module 15 is used for displaying the analysis information and the image information. To make it easy to understand the technical characteristics of the present invention, the following image information uses a figure display as a preferred embodiment, but the invention is not limited to such arrangement. Further, the normal body temperature of a person is approximately equal to 37. If the oral cavity temperature is higher than 37.5, it is determined as having a fever. If the fever continues at the temperature over 40, a brain function damage or even death may result. When the electronic clinical thermometer detects that a measured human body temperature of a person is over 39.5, such person is considered as having a high fever, so that a crying face is used for representing that the user feels uncomfortable, and the body temperature is too high and dangerous.

According to the temperature of 39.5 displayed by the display module 15, the user may input the observed temperature of 39.5 through the input module 12. It is noteworthy to point out that the input module 12 is an input device such as a keypad, a touchpad, or their combination. To make it easy to understand the technical characteristics of the present invention, the touchpad 3 is used in following as a preferred embodiment, but the invention is not limited to such arrangement. The input module 12 provides a handwriting input feedback information which is 39.5, and the storage module 16 stores a tracking of the handwriting information and the analysis information. The thermometer may provide the recognition module 13 to recognize the handwriting input as 39.5 and convert the handwriting input into digital information, so that the comparison module 14 compares the digital information to obtain a comparison result.

In other words, the comparison module 14 is used for comparing the image information with the handwriting information to obtain a comparison result and determine whether an error occurs in the conversion unit 112 of the analysis module 11. The comparison module 14 is used for comparing the analysis information with the digital information to obtain a comparison result and determine whether or not the computation unit 111 of the analysis module 11 operates normally. The comparison module 14 is provided for comparing the analysis information with the feedback information to obtain a comparison result, and to analyze and to determine whether or not the measured data is displayed by the display module 15 correctly. Finally, the display module 15 is used for displaying the comparison result, and the storage module 16 is used for storing the comparison result.

Therefore, the storage module 16 is used for storing the tracking of the handwriting information and the analysis information as a personal health record of the user, or a record for protecting the user's right in a medical dispute. The thermometer disclosed in this preferred embodiment is used as an example for illustrating but not limited to such arrangement, and those ordinarily skilled in the art should easily replace it with other equivalent devices for the electric device with data detection function 10 of the present invention.

Based on the first and second preferred embodiment, the present invention further provides the third preferred embodiment for the illustration as follows.

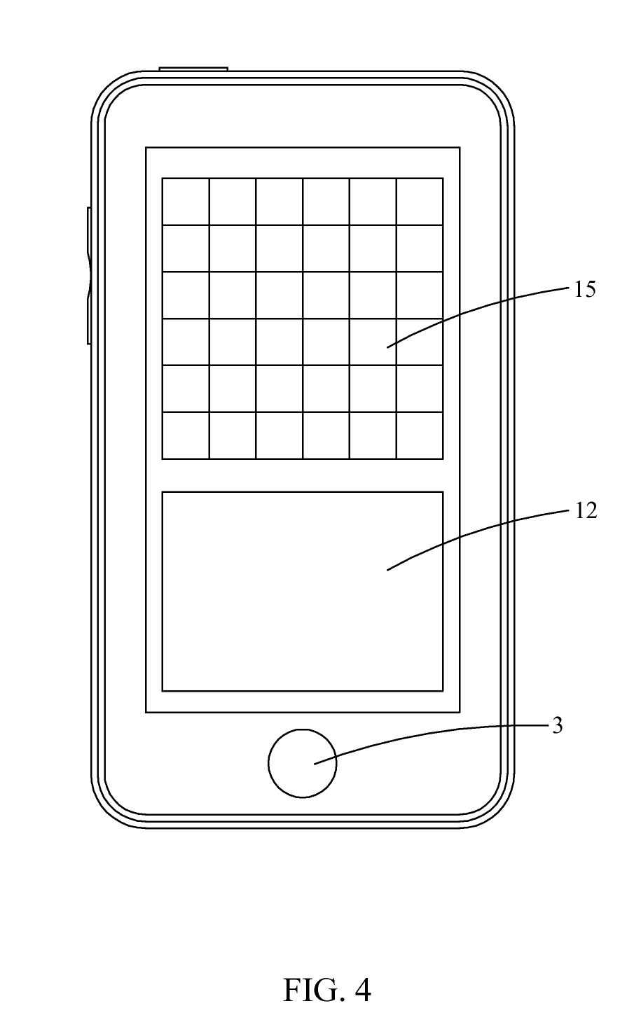

With reference to FIG. 4, for a schematic view of an electric device with data detection function in accordance with the third embodiment of the present invention, the electric device with data detection function 10 may be a medical measurement device, such as a glucose meter, an electronic clinical thermometer, a hemadynamometer, an oximeter, a Personal Digital Assistant (PDA), or a Smartphone, for detecting and measuring physiological conditions. To make it easy to understand the technical characteristics of the present invention, the Smartphone is used as an embodiment, but not intended for limiting the scope of the invention. In FIG. 4, the electric device with data detection function 10 of the present invention may be a Smartphone.

Referring to FIG. 1 as well, in this embodiment, the analysis module 11 may analyze and generate analysis information according to the sensor information, and the analysis module 11 may be a closed measurement system, such as a glucose meter, an electronic clinical thermometer, a hemadynamometer, or any other general measurement device capable of analyzing the sensor information and generating analysis information. The storage module 16 is used for storing the analysis information, and the storage module 16 may include an embedded memory, an external memory card or their combination. To make it easy to understand the technical characteristics of the present invention, the external memory card is used as an embodiment, but not intended for limiting the scope of the invention.

A general Smartphone is an open software platform, such as the Android or iPhone platform. A user can install or remove application software of the mobile phone freely. For example, the user may install the present most popular game “Angry Birds” into the Smartphone. However, once if the user has installed several application programs, it is difficult to regulate or verify the normal use of all functions. If the application software for measuring the blood glucose and other games are loaded and installed in the Smartphone, we are unable to predict whether or not a medical measurement error will occur after the user has installed other application software.

In this preferred embodiment, an external sensor may be built-in or externally connected to an electric device 10. To make it easy to understand the technical characteristics of the present invention, a sensor externally connected to the electric device 10 is used as an embodiment, but not intended for limiting the scope of the invention. Firstly, an external sensor (not shown in the figure) is provided for sensing the blood glucose value of the user, and storing the blood glucose value into the external memory card. The external memory card is inserted in the Smartphone, displaying the blood glucose analysis information or the image information transformed from analysis information through the display module 15. The image information is information such as a form, a figure or an animation. To make it easy to understand the technical characteristics of the present invention, the form is used as an embodiment in the following, but not intended for limiting the scope of the invention. In addition, the record file of the user's blood glucose values may be a fixed content, and may be revised constantly according to the actual conditions. For simplicity, the form is shown in the figure, and the detailed blood glucose values are listed in Table 1 as follows. Those with ordinarily skilled in the art may add other related parameters easily, and they are not described here.

TABLE 1
Records of a User's Blood Glucose Value at Different Time Periods

| | | | Feedback Blood |
|---|---|---|---|
| | Blood Glucose Value | | Glucose Value |
| Time | (mmol/L) | Remarks | (mmol/L) |
| 7:50 | 5.8 | Before meal | |
| 8:30 | 8.9 | One hour after | |
| | | meal | |
| 11:40 | 6.2 | Before meal | |
| 12:50 | 10.4 | One hour after | |
| | | meal | |
| 17:30 | 8.4 | Before meal | |
| 18:40 | 10.5 | One hour after | |
| | | meal | |

It is noteworthy to point out that the values displayed from the display module 15 are listed in Table 1, and the input module 12 is provided for the users for a handwriting input, such that the user can read the blood glucose value from the display module 15 and feed back the read value by inputting it into the column of the feedback blood glucose value, and a touchpad 3 is used for adjusting the input position of the table. The recognition module 13 is used for recognizing the information inputted into the table and converting the information into digital information. Hence, the comparison module 14 compares the analysis information with the digital information to obtain a comparison result and verify whether or not there is an analysis error made by the computation unit 111. The comparison module 14 is provided to compare the analysis information with the feedback information to obtain a comparison result and verify whether or not the display module 15 is operated normally. Therefore, the data detection method of the present invention may verify the accuracy of the data displayed and measured by the blood glucose meter. The Smartphone disclosed in this preferred embodiment is used as an example for illustrating the present invention, but not intended for limiting the scope of the invention. Those who ordinarily skilled in the art should be able to replace it with another equivalent device for the electric device with data detection function 10 of the present invention.

Even though the concept of the data detection method of the electric device with data detection function 10 in accordance with the present invention has been described in the description of the electric device with data detection function 10 in accordance with the present invention, the following flow chart is still provided with detailed descriptions for a clear description.

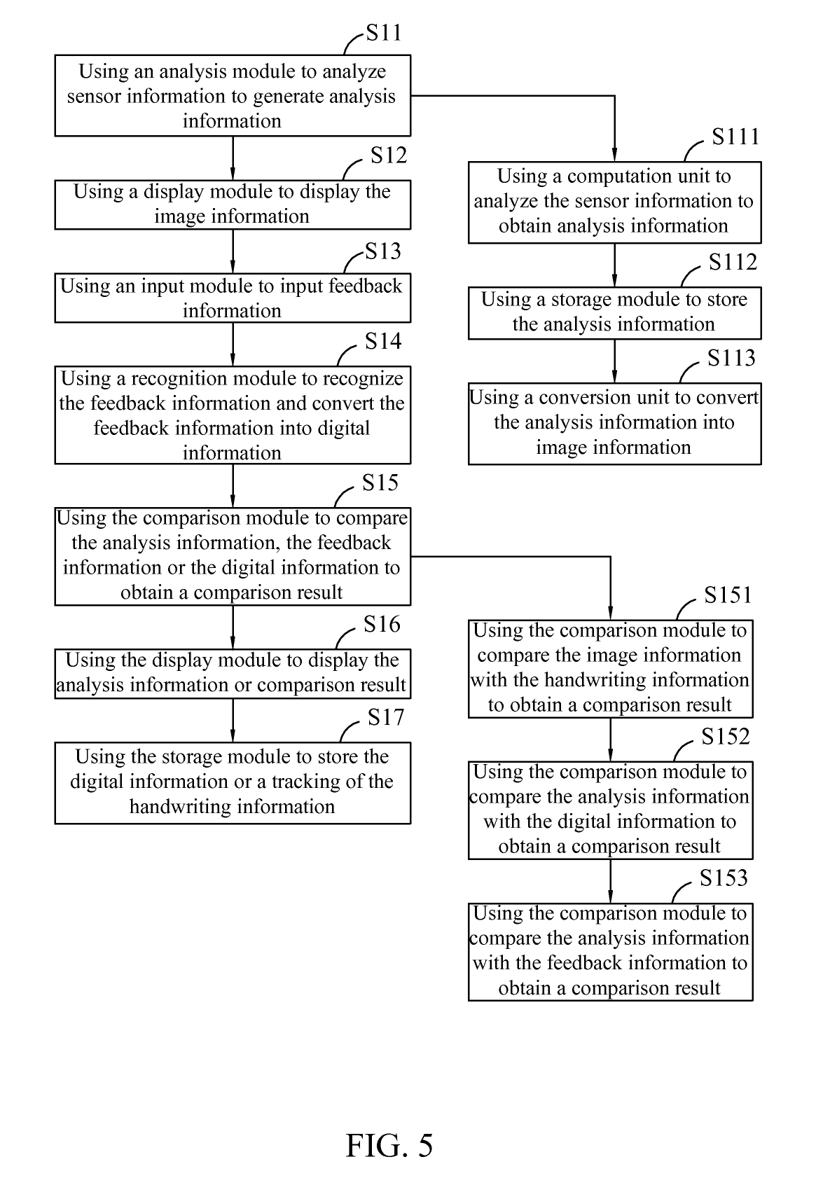

With reference to FIG. 5, for a flow chart of the data detection method of the present invention, the data detection method is applicable for an electric device with a data detection function, wherein the electric device with a data detection function comprises an analysis module, an input module, a recognition module, a comparison module and a display module. The data detection method of the electric device with a data detection function, first of all, as described in step S11, using an analysis module to analyze sensor information to generate analysis information. Wherein, the analysis module further includes a computation unit and a conversion unit, and Step S11 further comprises the following steps:

Step S111: Using a computation unit to analyze the sensor information to obtain analysis information;

Step S112: Using a storage module to store the analysis information; and

Step S113: Using a conversion unit to convert the analysis information into image information.

Next, as shown in Step S12 and Step S13, Step S12: Using a display module to display the image information; Step S13: Using an input module to input feedback information; and Step S14: Using a recognition module to recognize the feedback information and convert the feedback information into digital information. In Step S13, the input module may also be used to input handwriting information, and the recognition module of Step S14 is used to recognize the handwriting information and convert the handwriting information into digital information to facilitate a comparison of data takes place later. It is noteworthy to point out that the storage module is used for storing a tracking of the handwriting information, the analysis information and the digital information as medical history information for a user's reference.

Followed by the procedures as describe in step S15, Using the comparison module to compare the analysis information, the feedback information or the digital information to obtain a comparison result. The step S15 further comprises the following steps:

Step S151: Using the comparison module to compare the image information with the handwriting information to obtain a comparison result;

Step S152: Using the comparison module to compare the analysis information with the digital information to obtain a comparison result; and

Step S153: Using the comparison module to compare the analysis information with the feedback information to obtain a comparison result.

In other words, the comparison module may be used for comparing the information of the display module, the recognition module, the analysis module and the input module with each other effectively and respectively to obtain a comparison result. In step S151, the comparison result obtained by comparing the image information and the handwriting information may be used for determining whether or not the function of the recognition module is abnormal. In step S152, the comparison result of comparing the analysis information with the digital information may be used to determine whether or not the computation unit in the analysis module is operated an analyzed normally. In step S153, the comparison module compares the analysis information with the feedback information to obtain a comparison result to determine whether or not the display module is operated normally.

Thus, with the aforementioned data detection method, the comparison module is used for comparing with each other to obtain comparison results, and analyzing and determining whether or not the electric device with a data detection function is operated normally, so as to verify the accuracy of the data effectively.

Finally, in step s16 the display module is used to display the analysis information or comparison result. In step S17 the storage module is used to store the digital information or a tracking of the handwriting information.

In summation, the electric device with a data detection function in accordance with the present invention and the data detection method thereof have one or more of the following advantages:

1. The invention can overcome the problems of the prior art that cannot confirm the accuracy of the data view by the user.

2. The electric device with data detection function of the present invention and the data detection method thereof may reduce the errors occurred in the electric device effectively to prevent unexpected danger and improve the accuracy of the physiological information measured by the user.

3. The electric device with data detection function and the data detection method thereof may use the input module to input the feedback information, and use the comparison module to compare the analysis information, the feedback information or the digital information with each other to obtain the comparison result, such that the electric device may verify the accuracy of the measurement result effectively.

What is claimed is:

1. An electric device with data detection function, comprising:
an analysis module receiving sensor information to analyze and generate analysis information;
an input module inputting feedback information;
a recognition module electrically coupled to the input module, and recognizing and converting the feedback information into digital information;
a comparison module electrically coupled to the input module and the recognition module, and comparing the analysis information with the feedback information or the digital information, to generate a comparison result; and
a display module displaying the analysis information or the comparison result.

2. The electric device of claim 1, wherein the input module is a handwriting device, and the feedback information includes handwriting information, and the recognition module recognizes and converts the handwriting information into the digital information.

3. The electric device of claim 2, wherein the electric device comprises a storage module for storing a tracking of the analysis information, the digital information or the handwriting information.

4. The electric device of claim 2, wherein the analysis module further comprises a conversion unit for converting the analysis information into image information, and the comparison module compares the image information with the handwriting information to obtain the comparison result.

5. The electric device of claim 1, wherein the display module displays the analysis information and the comparison module compares the analysis information with the feedback information to obtain the comparison result.

6. The electric device of claim 1, wherein the analysis module further comprises a computation unit for analyzing the sensor information to obtain the analysis information, and the comparison module compares the analysis information with the digital information to obtain the comparison result.

7. The electric device of claim 1, wherein the electric device is a medical detection device, and the electric device further comprises a biosensor module for providing the sensor information.

8. An electric device with data detection function, comprising:
an analysis means for receiving and analyzing sensor information to generate analysis information;
an input means for inputting feedback information;
a recognition means for recognizing and converting the feedback information into digital information;
a comparison means for comparing the analysis information with the feedback information or the digital information to generate a comparison result; and
a display means for displaying the analysis information or the comparison result.

9. A data detection method, applicable for an electric device, and the electric device comprising an analysis module, an input module, a recognition module, a comparison module and a display module, and the method comprising the steps of:
analyzing sensor information to generate analysis information by the analysis module;
inputting feedback information by the input module;
recognizing and converting the feedback information into digital information by the recognition module;
comparing the analysis information, the feedback information or the digital information to obtain a comparison result by the comparison module; and
displaying the analysis information or the comparison result by the display module.

10. The data detection method of claim 9, wherein the feedback information further includes handwriting information, and the method further comprising the following steps of:
recognizing the handwriting information by the recognition module; and
converting the handwriting information into the digital information by the recognition module.

11. The data detection method of claim 10, further comprising the step of storing a tracking of the analysis information, the digital information or the handwriting information by a storage module.

12. The data detection method of claim 10, wherein the analysis module further comprises a conversion unit, and the data detection method further comprises the following steps of:
converting the analysis information into image information by the conversion unit; and
comparing the image information with the handwriting information to obtain the comparison result by the comparison module.

13. The data detection method of claim 9, further comprising the following steps of:
displaying the analysis information by the display module; and
comparing the analysis information with the feedback information to obtain the comparison result by the comparison module.

14. The data detection method of claim 9, wherein the analysis module further comprises a computation unit, and the data detection method further comprising the following steps of:
analyzing the sensor information to obtain the analysis information by the computation unit; and
comparing the analysis information with the digital information to obtain the comparison result by the comparison module.
